(19) United States
(12) Patent Application Publication
(10) Pub. No.: US 2005/0219209 A1
(43) Pub. Date: Oct. 6, 2005

(54) Keyboard for a hand-held portable computer

(75) Inventors: Rod G. Fleck, Bellevue, WA (US); Jeffrey M. Johnson, Medina, WA (US); Michael D. Smith, San Jose, CA (US); Michael S. Clarke, Mercer Island, WA (US); Thomas E. Meyerhoffer, Montara, CA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vulcan Portals Inc., Seattle, WA (US)

(21) Appl. No.: 11/058,915

(22) Filed: Feb. 15, 2005

Related U.S. Application Data
(63) Continuation-in-part of application No. 10/338,791, filed on Jan. 7, 2003.

(51) Int. Cl. G09G 5/08

(52) U.S. Cl. 345/157

(57) ABSTRACT

A hand-held portable computer has a mouse button that is surrounded in close proximity by directional buttons. Placing the directional-buttons in close proximity around the mouse button makes on-screen navigation easier, since the same single finger need only be moved by a small amount to actuate one or more of these buttons. If the mouse button is actuated, a mouse cursor can be moved about a page displayed on a display screen. If the directional buttons are actuated, the page can be panned around the display screen, while the mouse cursor remains stationary. The portable computer is also provided with a plurality of hot keys, and with buttons that are located off its keyboard, such as at the back of the portable computer. In other embodiments, a touchpad is provided, along with left and right mouse buttons located adjacent to one or more directional arrow buttons. In another embodiment, the left and right mouse buttons are located on opposing regions of a keyboard.

### CROSS-REFERENCE TO RELATED APPLICATION

This application is a continuation-in-part of U.S. patent application Ser. No. 10/338,791, entitled “KEYBOARD WITH MOUSE FOR A HAND-HELD PORTABLE COMPUTER,” filed Jan. 7, 2003, now pending, which application is assigned to the same assignee as the present application and is incorporated herein by reference in its entirety.

### TECHNICAL FIELD

The present disclosure relates generally to hand-held portable electronic devices, and in particular but not exclusively, relates to a keyboard for a hand-held portable computer having a small form factor.

### BACKGROUND INFORMATION

Modern desktop computers provide users with user-input mechanisms that are well suited for the applications that run on these computers. For example, desktop computers often use an external peripheral mouse that allows the user to conveniently navigate through menus, panes, and features of an application, as well as allowing navigation between applications and selection of various choices (usually via a “point and click” or a “click and drag”) within a given application. Moreover, applications usually provide complex, yet convenient, graphical user interfaces (GUIs) that are designed to work in conjunction with the point and click features of a mouse or with particular keys on a keyboard of the desktop computer.

The nature of desktop computers makes them ideal for using user-input devices such as an external peripheral mouse and/or keyboard. There is usually sufficient desktop space or keyboard size to allow the user to easily navigate through an application or to select from various choices, without having to struggle with finger dexterity issues and awkward positioning. However, with laptop computers, a common complaint from users is that the keyboard is too small or that the mouse is difficult to control. The user has to “crowd” his fingers in order to properly use and select the appropriate keys on the cramped keyboard, and has to use a mouse that is more difficult to use because it is physically integrated within the keyboard, rather than being an attached external peripheral that can be conveniently used at arm's length away from the keyboard.

While laptops do have these disadvantages, they are, for the most part, adequate in terms of navigation and selection controls (via the mouse and keyboard). However, with ultra-portable devices, such devices typically have a substantially smaller form factor than a laptop or desktop computer. Their keyboards are significantly smaller than normal laptops and desktop computers, with “tiny” keys on the keypad. The keypads are of such a small size that the user can typically use only one or two fingers at a time to perform typing, or to perform clicking and dragging with a mouse integrated on the keyboard. This small keyboard size thus results in a very inconvenient user input mechanism.

Moreover, these devices also have a correspondingly and significantly smaller display screen size. The small display screen size, coupled with the small keyboard size, makes use of a mouse for navigation and selection extremely difficult. First, it is difficult for the user to see the “arrow” or cursor (representing the mouse) on the small display screen. Second, it is difficult to provide mouse functionality on the keyboard itself, due to the small size of the keyboard. Even if a mouse were integrated into the keyboard of a small hand-held device in a manner similar to conventional laptop computers, the mouse would be difficult to maneuver or otherwise control with a single fingertip. Imagine the awkwardness, for instance, of trying to hold the portable device with the left hand, while trying to maneuver the mouse with a fingertip from the right hand.

### BRIEF SUMMARY OF THE INVENTION

One preferred aspect provides an apparatus that includes a hand-held electronic device having a small form factor. A mouse device and at least one directional button are located on the electronic device. Left and right mouse buttons are located on the electronic device and at least one of the mouse buttons is positioned adjacent to the at least one directional button.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various views unless otherwise specified.

FIG. 1 shows a portable hand-held computer in accordance with an embodiment.

FIG. 2 is a rear-side view of the portable computer of FIG. 1, showing additional buttons in accordance with an embodiment.

FIG. 3 shows an embodiment of a keyboard and a mouse assembly for the portable computer of FIGS. 1-2.

FIGS. 4-6 are example screen shots illustrating operation of the mouse assembly of FIG. 3 in accordance with embodiments.

FIG. 7 is an example screen shot of a form that can be navigated through using the buttons depicted in FIG. 2 in accordance with an embodiment.

FIG. 8 is another illustration of the portable hand-held computer in accordance with an embodiment.

FIG. 9 is an illustration of the embodiment of the portable hand-held computer of FIG. 8 in comparison with a laptop computer.

FIG. 10 is an illustration of the embodiment of the portable hand-held computer of FIG. 8 in comparison with a cellular telephone.

FIG. 11 shows an embodiment of a keyboard for the portable computer of FIGS. 1-2.

FIG. 12 shows another embodiment of a keyboard for the portable computer of FIGS. 1-2.

FIG. 13 shows yet another embodiment of a keyboard for the portable computer of FIGS. 1-2.

### DETAILED DESCRIPTION

Embodiments of a keyboard and buttons for a hand-held device (such as a portable computer having a small form factor) are described herein. In the following description, numerous specific details are given to provide a thorough understanding of embodiments. The invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment provides a hand-held portable electronic device, such as a portable computer having a small form factor. The portable computer has a keyboard that is arranged in a manner that is comfortable and convenient to use by a user, considering the significantly smaller overall size of the portable computer and of its keyboard and display screen. In particular, the keyboard includes (or is adjacent to) a mouse assembly (or other similar cluster) having a mouse button and directional buttons.

The mouse button can be clicked to perform typical mouse-click operations. The directional buttons are placed in close proximity to the mouse button, in an arrangement where the directional buttons at least partially surround the mouse button. The directional buttons correspond to right/left and up/down arrow keys (as well as page up/down buttons) typically found on a conventional keyboard. However, by arranging these directional buttons in close proximity around the mouse button, the user can more easily use a single fingertip (such as a thumb) to perform navigation through a user interface on the display screen of the portable computer. The user need only move his thumb slightly in one direction or another, pressing the appropriate directional buttons in the process, to easily navigate through the user interface. Moreover, concentrating the mouse and directional buttons in a clustered area contributes to the overall small form factor of the portable device, where real estate is a premium.

Accordingly, the cursor corresponding to the mouse button can be kept stationary on the display screen, while the directional buttons are used to “pan” across the page or screen, such as up or down or left or right. Once a particular portion of the page has been positioned in this manner under the cursor, the user can click the mouse button to select a desired item that is located at that portion of the page.

In an embodiment, the keyboard of the portable computer further includes left and right mouse buttons, which are located in another region of the keyboard different from the mouse assembly. The portable computer can further include a plurality of “hot keys” that allow the user to quickly launch applications and to switch from one application to another, without the need to explicitly navigate to and select these application via the display screen. In yet another embodiment, buttons can be conveniently located off the keyboard, such as at the rear side of the portable computer, where the user's fingertips can easily locate and press these buttons. These buttons may be used for tabbing and “enter,” such as when filling out fields in an on-screen form, for instance.

In other embodiments, the left and right mouse buttons are located next to the directional buttons. In one such embodiment, the mouse button is replaced with a touchpad (mousepad) that is exterior to (e.g., not substantially surrounded by) the directional buttons, and the left and right mouse buttons are located to the left of the directional buttons. In yet another embodiment, the directional buttons are located on opposite sides of the keyboard, such as on a left-hand region of the keyboard (for the left mouse button) and on a right-hand region of the keyboard (for the right mouse button).

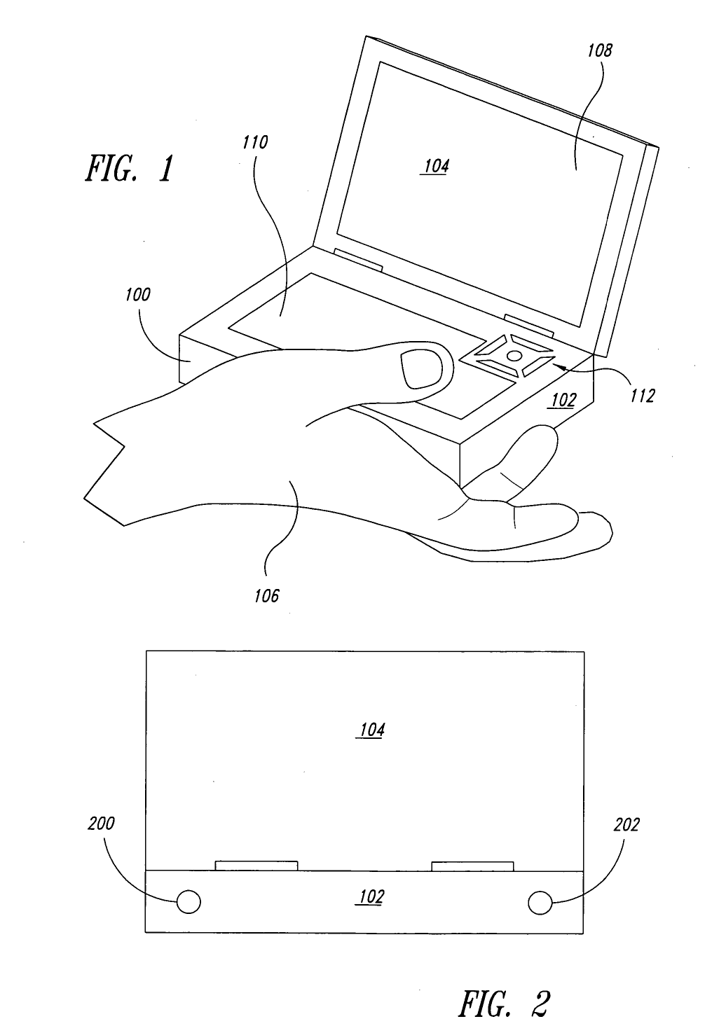

FIG. 1 shows a portable hand-held computer 100 in accordance with an embodiment. While the portable computer 100 is used as the illustrative example throughout this application, other embodiments may be implemented with devices that may not necessarily be thought of as a “computer” by the average individual. Examples include wireless communication devices, display devices, monitors, audiovideo equipment, consumer electronic devices, or other electronic device that can have a reduced form factor and that can benefit from the mouse assembly, keyboard, or additional buttons described herein.

As shown, the portable computer 100 is similar in appearance to a laptop, in that it comprises first and second portions 102 and 104, respectively. The first portion 102 can include a keyboard 110 and housing for the internal electronic components (such as a processor, disk drives, graphics drivers, and so forth). The first portion 102 further includes a mouse assembly 112 or other cluster of buttons. The keyboard 110 and the mouse assembly 112 will be described in further detail later below. The second portion 104 folds over the first portion 102 (when in a closed position), and includes a display screen 108 for displaying information while the second portion 104 is unfolded to an upright position (as shown in FIG. 1).

Unlike a conventional laptop, however, the portable computer 100 is substantially smaller in size in terms of both volume and weight. An example dimensional size of the portable computer 100 is 140 mm long, 100 mm wide, and 30 mm thick (while closed), with a weight of approximately one pound. The display screen 108 on the second portion 104 is of a resolution comparable to a desktop computer monitor. In general, the size of the display screen 108, the size of the internal components (e.g., chips and circuit boards) located within the first portion 102, and the strategic placement of the internal components (e.g., density), and other factors will influence the overall form factor of the portable computer 100. As illustrated in FIG. 1, the portable computer 100 has a size such that it can be held securely in a hand 106 of a user.

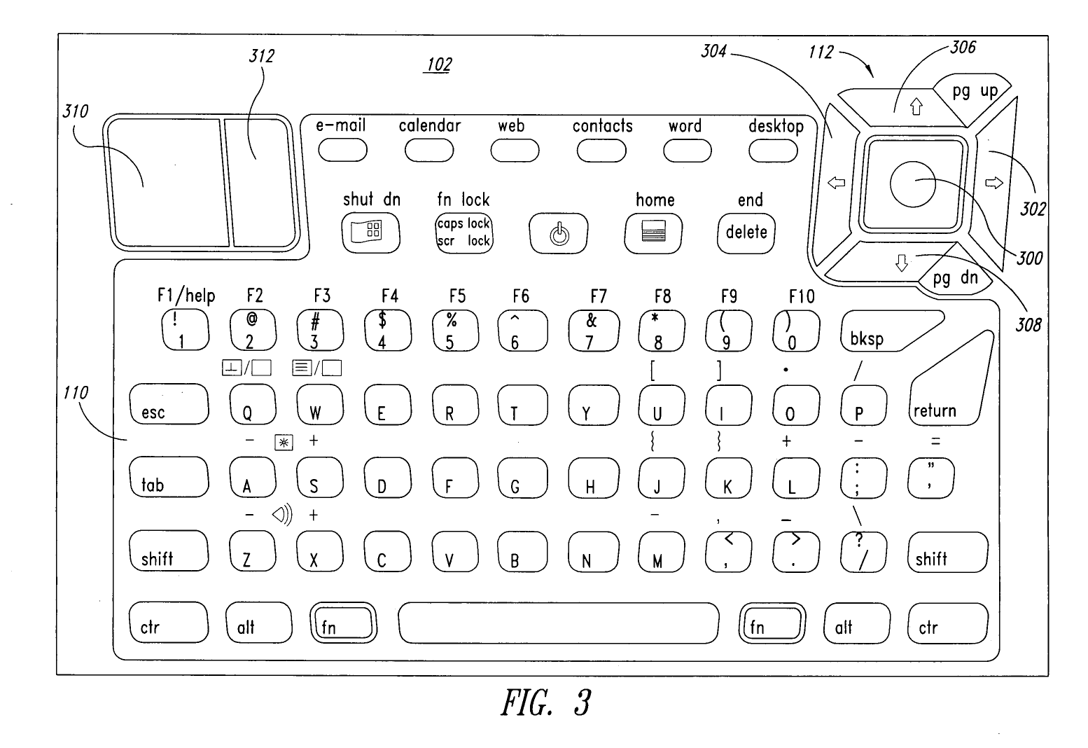

FIG. 2 is a rear-side view of the portable computer 100 of FIG. 1, showing additional buttons 200 and 202 in accordance with an embodiment. These buttons are located on the rear-side surface of the first portion 102, such that the user's fingertips, when extended, can easily reach, locate, and press these buttons 200 and 202. However, these or other off-keyboard buttons may be located else where on the housing of the portable computer 100.

The buttons 200 and 202 can comprise buttons that can be physically pressed, or they can comprise touchpad types of buttons that can sense finger pressure to determine whether a press is being performed. One example use of the buttons 200 and 202 will be explained later below with reference to FIG. 7.

FIG. 3 shows an embodiment of the keyboard 110 and the mouse assembly 112 for the portable computer 100 of FIGS. 1-2. The mouse assembly 112 includes a mouse button 300, which can be used to control the positioning of a cursor on the display screen 108 and for selecting and clicking on items in a user interface presented thereon. The mouse button 300, in one embodiment, can be similar to mouse buttons found on typical laptop computers. That is, the mouse button 300 is mounted in the first portion 102 in a manner that it can be physically rotated or otherwise moved (to cause corresponding movement of the screen cursor) by applying directional fingertip pressure. The mouse button 300 of this embodiment is also self-centering in that it moves back to a centered position when the fingertip pressure is removed—this allows the mouse button 300 to re-center automatically without requiring the user to reposition the mouse button 300 to its original orientation. In an embodiment, the mouse button 300 can be pressed vertically (or “tapped”) by a fingertip to perform a mouse click.

Because of the small form factor of the portable computer 100, the mouse button 300 is located in the upper right corner of the first portion 102. This allows the user's right hand to comfortably grip the first portion 102, while positioning the right thumb over the mouse button 300. Thus, the right thumb of the user's hand 106 can be used to actuate the mouse button 300. The mouse button 300 can comprise part of the keyboard 110 itself, or it can be separated from but adjacent to the keyboard 110.

In an embodiment, a plurality of directional buttons 302-308 at least partially surrounds the mouse button 300 and are positioned adjacent to the mouse button 300 in close proximity. Right and left arrow buttons 302 and 304, respectively, are located to the right and left, respectively, of the mouse button 300. The right arrow button 302 is used to incrementally pan the display screen 108 to the right, and the left arrow button 304 is used to incrementally pan the display screen 108 to the left. In an embodiment, this right/left panning can occur while the mouse cursor is kept stationary on the display screen 108, as will be illustrated and described later below.

The right arrow button 302 and the left arrow button 304 may have generally elongated vertical shapes, and can be positioned several millimeters away from the mouse button 300, with the mouse button 300 centered between them. This allows the user to rest his thumb over the mouse button 300, and then actuate the right arrow button 302 or the left arrow button 304 by simply “rocking” his thumb sideways. Therefore, a convenient mechanism for horizontal navigation and selection is provided by the mouse button 300, the right arrow button 302, and the left arrow button 304, since the user does not have to reposition his fingertips across the keyboard 110 in order to find and actuate horizontal navigation keys.

In a similar manner, up and down arrow buttons 306 and 308, respectively, are located to the top and bottom, respectively, of the mouse button 300. The up arrow button 306 is used to incrementally pan the display screen 108 upward, and the down arrow button 308 is used to incrementally pan the display screen 108 downward. In an embodiment, this up/down panning can occur while the mouse cursor is kept stationary on the display screen 108, as will be illustrated and described later below.

The up arrow button 306 and the down arrow button 308 may have generally elongated horizontal shapes, and can be positioned several millimeters away from the mouse button 300, with the mouse button 300 centered between them. Again, this arrangement allows the user to rest his thumb over the mouse button 300, and then actuate the up arrow button 306 or the down arrow button 308 by simply “rocking” his thumb forward and backward, respectively. Therefore, a convenient mechanism is also provided for vertical navigation and selection by the mouse button 300, the up arrow button 306, and the down arrow button 308, since the user does not have to reposition his fingertips across the keyboard 110 in order to find and actuate vertical navigation keys.

It is noted that the up arrow button 306 and the down arrow button 308 may also be used to perform page up and page down operations, respectively. That is, these buttons may each be broken into two segments in an embodiment, where one segment is used to perform the incremental line-by-line navigation, while the second segment is used to perform the paginated navigation. In another embodiment, whether line-by-line navigation or paginated navigation is performed depends on which side of the elongated button the user is applying his thumb pressure. In yet another embodiment, a single one of the buttons (e.g., the button is not segmented) may be used to perform both operations, such as by also pressing a shift key in addition to the directional button when paginated movement is desired.

In an embodiment, the mouse assembly 112 may be provided with acceleration and interpolation capabilities. That is, the degree of fingertip pressure and direction can be sensed in order to accelerate the direction of cursor movement in a particular direction. For example, users may tend to press the mouse button 300 and/or directional buttons 302-308 harder when they wish to speed up cursor movement. An embodiment detects this directional fingertip pressure to interpolate both the degree of acceleration and the general direction where movement is desired.

In an embodiment, the keyboard 110 can include or have positioned adjacent to it, left and right mouse buttons 310 and 312, respectively. These buttons 310 and 312 perform similar functions as their counterparts on a hand-held mouse for a desktop computer. A difference is that the buttons 310 and 312 are positioned in a location on the keyboard 110 where they can be actuated with the left thumb (e.g., they are located at the upper left corner of the first portion 102), while the right thumb performs navigation of the mouse cursor using the mouse assembly 112.

In an embodiment, the keyboard 112 includes a plurality of “hot keys.” The hot keys illustrated in FIG. 3 include, but are not limited to, email, calendar, web, contacts, word, and desktop hot keys. These hot keys may be thought of as “accelerator” keys. That is, they accelerate the launching or activating of an application, without requiring the user to perform on-screen navigation. Reducing the requirements for on-screen navigation is an advantage with the portable computer 100, since its small form factor weighs against convenient navigation.

As an illustration, the user can press the email hot key to launch an email application. If the user then subsequently presses the web hot key, the email application becomes inactive, and a web browser application launches and becomes active. If the user then presses the email hot key again, the email application does not re-launch. Rather, the previously launched email application goes from inactive to active state, while the web browser application goes inactive. Thus, the hot keys of an embodiment provide a convenient mechanism to “flip” between applications, without the user having to navigate to on-screen status bars using a mouse cursor. Again, the reduction of the requirements to perform on-screen navigation is an advantage for the portable computer 100 that has a small form factor, since the display screen 108 has a small size (e.g., its displayed items are difficult to view).

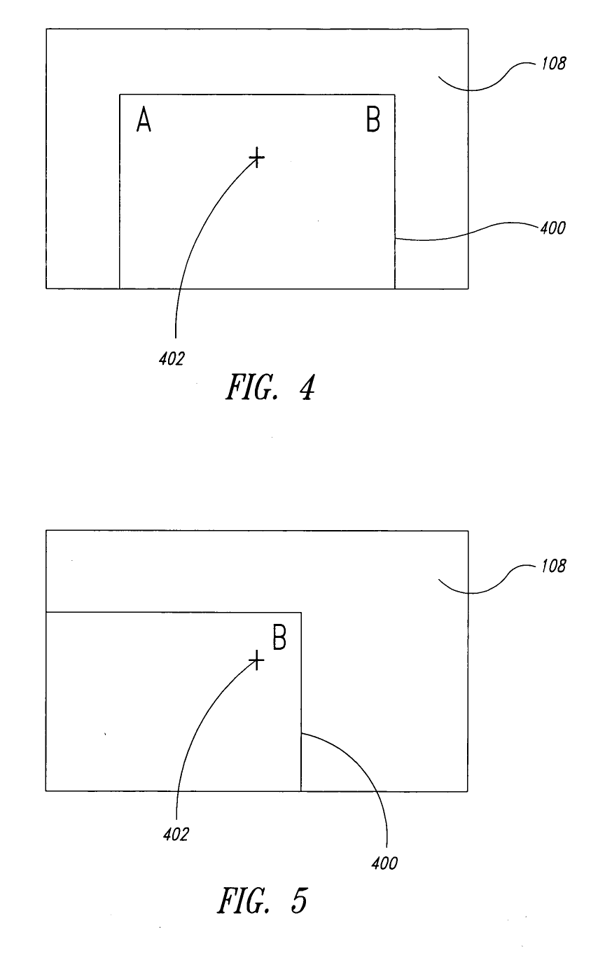

FIGS. 4-6 are example screen shots illustrating operation of the mouse assembly 112 of FIG. 3 in accordance with embodiments. In FIG. 4, a portion of a page 400 is rendered on the display screen 108. The page 400 may be a portion of a web page or a Microsoft Word™ document, for instance. The letters A and B symbolically represent the upper left and upper right regions of the page 400, respectively. A mouse cursor 402 is positioned in a generally center region of the display screen 108.

In one embodiment, the user can actuate the mouse button 300 to move the mouse cursor 402 about the page 400, while the page 400 remains stationary within the display screen 108 (unless of course the mouse cursor 402 reaches the edge of the displayed page 400, in which case the display screen 108 will scroll to the adjacent region of the page 400). However, an embodiment allows the user to keep the mouse cursor stationary, while the page 400 itself is repositioned or panned.

An example of this situation is illustrated in FIG. 5. In FIG. 5, the mouse cursor 402 has remained stationary, since the user has not actuated the mouse button 300. Instead, the user has clicked on the right arrow button 302 to pan to the right, and therefore the upper left region A of the page 400 has moved off-screen. The user may similarly click on the left arrow button 304 to pan to the left to show the upper left region A and to move the upper right region B off-screen.

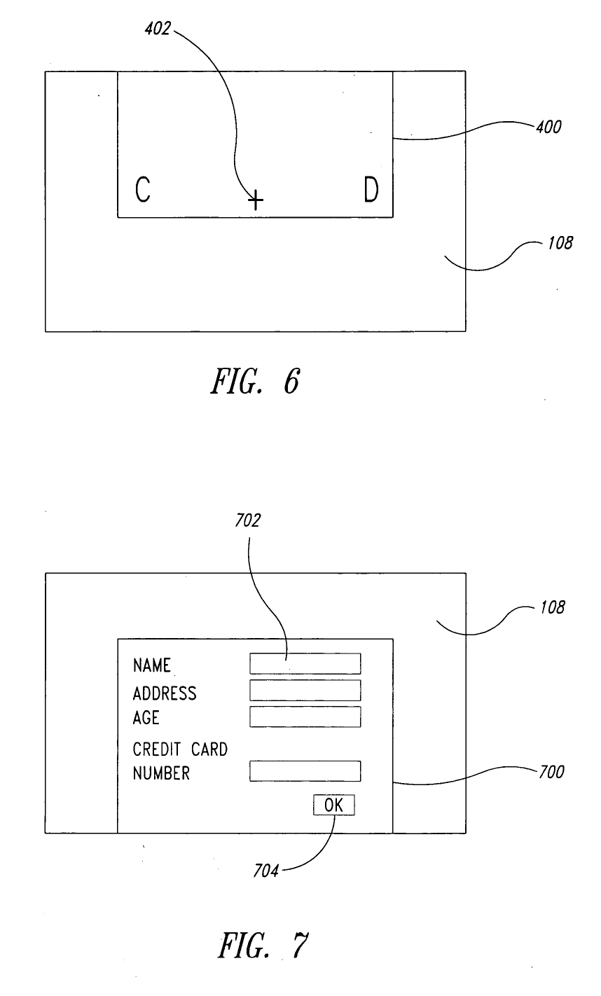

FIG. 6, in comparison to the screen shot of FIG. 4, is a screen shot after the user has used the down arrow button 308 to pan towards the bottom of the page 400. The upper left region A and the upper right region B have moved off-screen, while a lower left region C and a lower right region D of the page 400 have appeared on-screen. The mouse button 300 was not actuated, and therefore, the mouse cursor 402 has remained stationary.

It is noted that any combination of the directional buttons 302-308 may be used along with or to the exclusion of the mouse button 300, to achieve navigation in any desired direction. For the sake of simplicity and brevity, such directional positioning will not be further described or illustrated herein, since performance of such positioning would be familiar to one skilled in the art after having reviewed the previous discussion and accompanying drawings.

FIG. 7 is an example screen shot of a form 700 that can be navigated through using the buttons 200 and 202 depicted in FIG. 2 in accordance with an embodiment. For purposes of illustration, the button 202 will be described in terms of providing a tab operation, while the button 200 provides an enter operation. In some embodiments, these or other off-keyboard buttons can perform other types of operations. In an embodiment, the buttons 200 and 202 (or other off-keyboard buttons) are user-programmable.

The form 700 can comprise, for instance, an on-line form that is provided by way of a web page. The form 700 has a plurality of fields 702 where the user has to enter information, such as when performing an on-line purchase or requesting information. Ordinarily, the user of a desktop computer would have no difficulty using a peripheral mouse or keyboard tab keys to move from one field to another. However, with a hand-held device having a small form factor, such as the portable computer 100, use of a mouse or the keyboard tab key can be difficult. The keyboard tab key is small in size, and the mouse button 300 has to be skillfully used to maneuver the mouse cursor 400 from one field to another, where the form 400 is rendered in the small display screen 108.

Accordingly, the button 202 can be used as a tab key to tab from one field 702 to another, without having to use the mouse button 300 or the keyboard tab key. Use of the button 202 allows the user to accelerate navigation through the form 700.

Once the form 700 has been completed, the user can maneuver the mouse cursor 400 over an OK button 704 and click it. Alternatively, the user may locate and press the Enter key on the keyboard 110. Still alternatively, the user can press the button 200 on the rear side of the portable computer. The button 200 operates as an Enter key, and is more conveniently located and actuated as compared to the mouse cursor 400 and the Enter key on the keyboard 110.

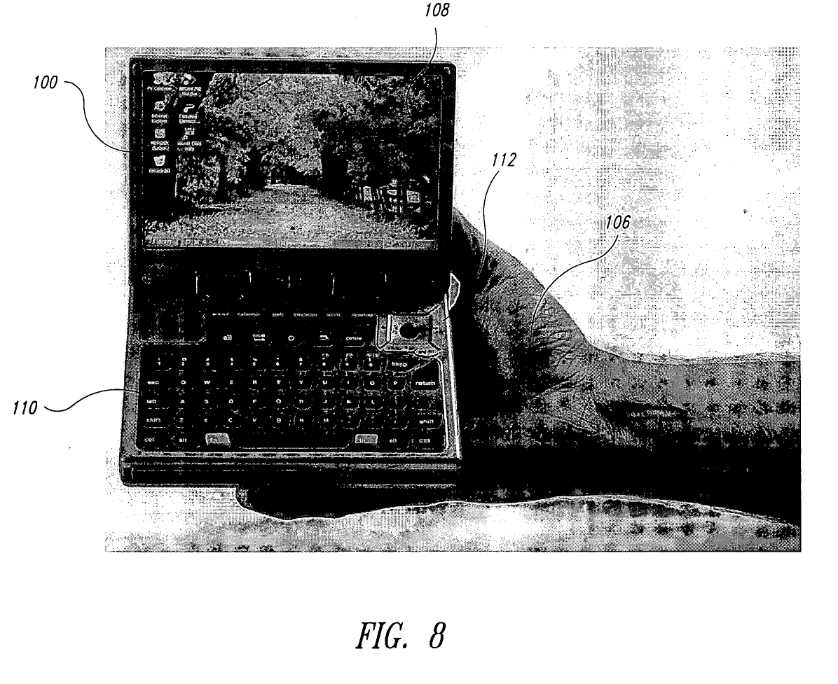

FIG. 8 is another illustration of the portable hand-held computer 100 in accordance with an embodiment. In particular, FIG. 8 illustrates an actual size of an embodiment, in a manner that the compact size allows the portable computer to be held in the hand 106 of the user. The keyboard 110 and the easily accessible mouse assembly 112 are also shown in the figure.

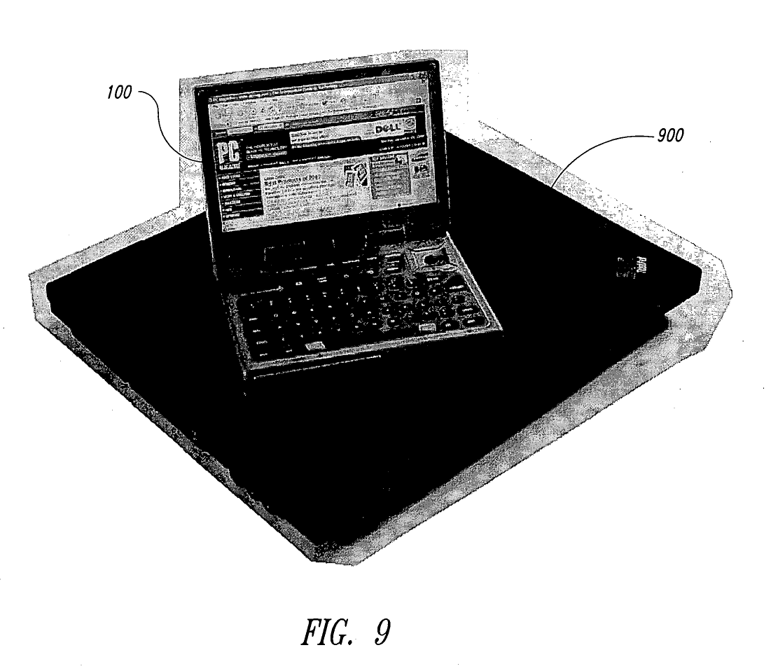

FIG. 9 is an illustration of the embodiment of the portable computer 100 of FIG. 8 in comparison with a laptop computer 900. As depicted, the embodiment has a size that is significantly smaller than that of the laptop computer 900, while still providing capabilities (software, hardware, keyboard, display screen, navigation, and so forth) that are useful to a user.

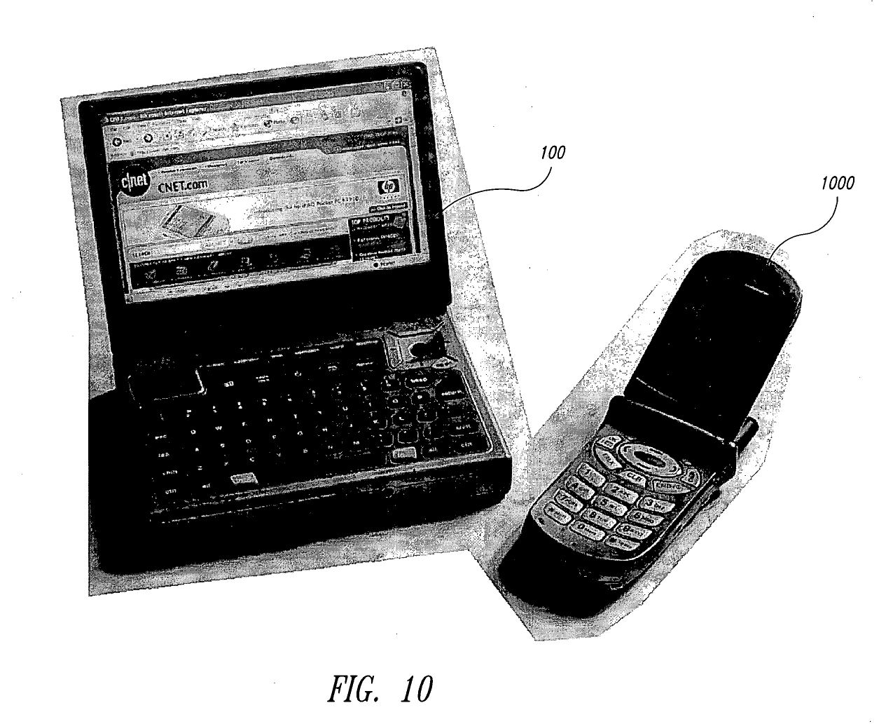

FIG. 10 is an illustration of the embodiment of the portable computer 100 of FIG. 8 in comparison with a cellular telephone 1000. Again, the compact size of the embodiment of the portable computer 100 is apparent, being larger (but not much larger) than the cellular telephone 1000.

Various other features of embodiments of the portable computer 100 are disclosed in U.S. application Ser. No. 10/338,802, entitled “SYSTEM AND METHOD FOR HEAT REMOVAL FROM A HAND-HELD PORTABLE COMPUTER WHILE DOCKED”; U.S. application Ser. No. 10/338,815, entitled “NAVIGATION AND SELECTION CONTROL FOR A HAND-HELD PORTABLE COMPUTER”; and U.S. Pat. No. 6,839,231, entitled “HEAT DISSIPATION FROM A HAND-HELD PORTABLE COMPUTER,” all assigned to the same assignee as the present application, and incorporated herein by reference in their entireties.

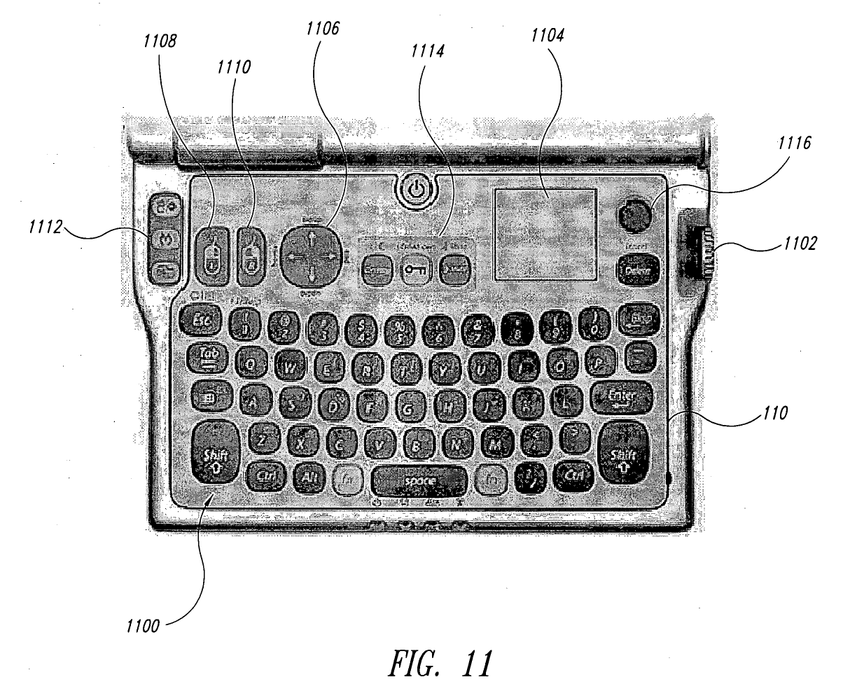

Other embodiments for the keyboard 110 can be provided. FIGS. 11-13 illustrate various non-limiting and non-exhaustive example embodiments of the keyboard 110. With these and other embodiments described herein, various individual features of the keyboard 110 can be added, removed, combined, or modified to create yet further embodiments.

In the embodiment of FIG. 11, the keyboard 110 includes a set of buttons 1100 arranged in a QWERTY configuration. A thumb-operated track wheel 1102 is positioned adjacent to the keyboard 110, such as at the right side of the housing of the portable computer 100. The track wheel 1102 is usable for navigation and/or selection operations, alternatively or in addition to the other buttons of the keyboard 110.

In an embodiment, a touchpad (or mousepad) 1104 is provided. The touchpad 1104 of this embodiment provides a small, touch-sensitive pad usable as a pointing device on the portable computer 100. By moving a finger or other object along the touchpad 1104, the user can move a pointer (such as a cursor) on the display screen 108. Clicking can be performed by tapping the touchpad 1104. The touchpad 1104 can be provided alternatively or additionally to the mouse button 300 of FIG. 2.

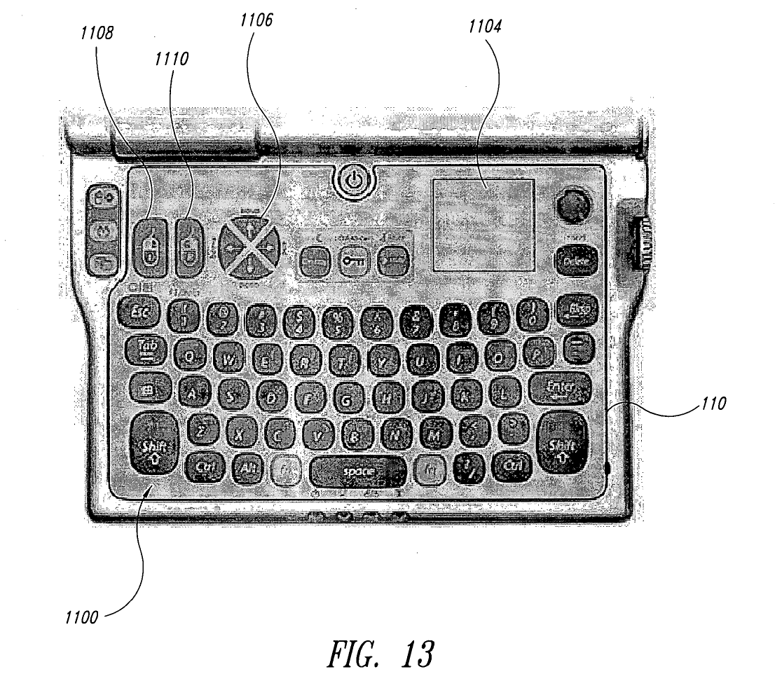

The keyboard 110 can further include one or more directional arrow buttons 1106. In the embodiment depicted in FIG. 11, directional arrows (up, down, left, right) are integrated on a single button 1106. Thus, selection of a particular directional arrow can be achieved by applying fingertip pressure to an appropriate surface region of the button 1106. In an embodiment depicted in FIG. 13, separate individual arrow buttons 1106 (rather than a single integrated button) are provided for up, down, left, and right directions.

The various directional arrows of the button(s) 1106 can be used to perform cursor navigation across the display screen 108 and/or to perform paginated navigation such as depicted in FIGS. 4-6. Alternatively or additionally, the various directional arrows can be used for page up, page down, panning, or other viewing-related navigation.

A left mouse button 1108 and a right mouse button 1110 are provided in the embodiments of FIGS. 11 and 13. The left mouse button 1108 and the right mouse button 1110 are substantially similar, respectively, to the left mouse button 310 and right mouse button 312 of FIG. 2, except that the left mouse button 1108 and the right mouse button 1110 of the embodiments of FIGS. 11 and 13 are collectively located next to or otherwise adjacent to the directional arrow button(s) 1106.

In the example embodiment depicted in FIGS. 11 and 13, the left mouse button 1108 and the right mouse button 1110 are located to the left of the directional arrow button(s) 1106. In other embodiments, the left mouse button 1108 and the right mouse button 1110 can be located above, below, to the right of, diagonally to, etc. the directional arrow button 1106. The left mouse button 1108 and the right mouse button 1110 can be located immediately adjacent to the directional arrow button(s) 1106 such that there are no intervening buttons between them. In other embodiments, the left mouse button 1108 and the right mouse button 1110 can be located in close proximity to the directional arrow button(s) 1106 such that there may be some intervening button(s) between them. Such an embodiment considers the small form factor (e.g., limited keyboard real estate) of the portable computer 100 by minimizing the number of intervening buttons between the left/right mouse buttons 1108/1110 and the directional arrow button(s) 1106.

Furthermore, the embodiment depicted in FIG. 11 has the left mouse button 1108 and the right mouse button 1110 located on the left-hand region of the keyboard 110. Accordingly, the user's left thumb (or other finger from the user's left hand) can be used to actuate the left mouse button 1108 and the right mouse button 1110. The left mouse button 1108 and the right mouse button 1110 of another embodiment can be located elsewhere on the keyboard 110. For instance, both the left mouse button 1108 and the right mouse button 1110 can be located on the right-hand region of the keyboard 110 (such as near the touchpad 1104) to permit the user's right thumb (or other finger from the user's right hand) to actuate the left mouse button 1108 and the right mouse button 1110. In yet other embodiments, the left mouse button 1108 and the right mouse button 1110 can be located at any suitable location on the keyboard 110.

Various other buttons can be provided for the keyboard 110. For example in FIG. 11, a plurality of hot keys 1112 can be provided that allow the user to quickly launch applications and/or to switch from one application to another. Buttons 1114 can be provided for certain applications as well, such as communications or security applications, as non-limiting and non-exhaustive examples. A power on/off button 1116 can be located on the keyboard 110 or elsewhere on the portable computer 100.

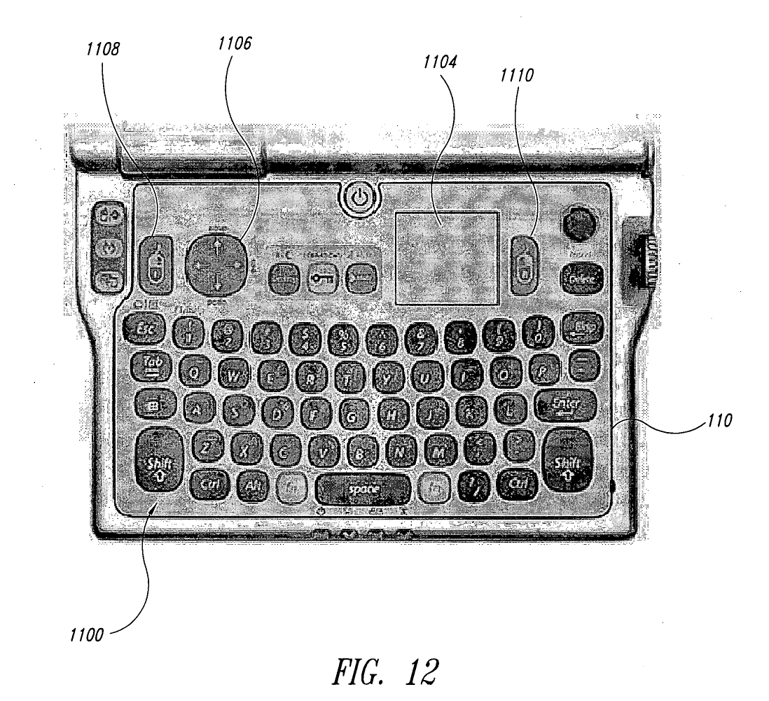

In an embodiment depicted in FIG. 12, the left mouse button 1108 is located on the left-hand region of the keyboard 110, while the right mouse button 1110 is located on the right-hand region of the keyboard 110. Placement of the left mouse button 1108 and the right mouse button 1110 on opposing or alternate sides of the keyboard allows the user to use fingers from different hands to actuate these buttons. For example with the embodiment of FIG. 12, the user's left thumb can be used to actuate the left mouse button 1108, while the user's right thumb can be used to actuate the right mouse button 1110.

The various embodiments of the keyboard 110 depicted in the figures and described herein are non-exhaustive and non-limiting. For instance, certain shapes for the buttons are shown as being generally rectangular with rounded corners. Other button shapes are possible, including circular or elliptical, just to name a couple of examples. Moreover, for the embodiments of FIGS. 11-13, the mouse button 300 can be substituted for the touchpad 1104, such as in situations where it is desirable to have smaller keyboard real-estate utilization by a mouse device.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible and can be made without deviating from the spirit and scope of the invention.

For instance, the mouse assembly 112 has been illustrated and described herein as a cluster of physical buttons that are in close proximity to each other. The mouse button 300, for example, can be embodied as a clickable trackball or other different mechanism, as opposed to the mechanism described above. In an embodiment, for instance, the mouse assembly 112 can be embodied as one or more touch pads or as soft keys. Moreover, the mouse assembly 112 can be positioned in other regions of the portable computer 100 (such as adjacent to a left region of the keyboard 110, for left-handed users), alternatively to being adjacent to the upper right region of the keyboard 110 as illustrated.

These and other modifications can be made in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a hand-held electronic device having a small form factor;
a mouse device located on the electronic device;
at least one directional button located on the electronic device; and
left and right mouse buttons located on the electronic device and at least one of the mouse buttons being positioned adjacent to the at least one directional button.

2. The apparatus of claim 1 wherein the mouse device comprises a touchpad.

3. The apparatus of claim 1 wherein the at least one directional button comprises a plurality of separate directional arrow buttons.

4. The apparatus of claim 1 wherein the at least one directional button comprises a single button having different surface regions that can be actuated to perform corresponding different directional navigation.

5. The apparatus of claim 1 wherein the left and right mouse buttons are collectively positioned immediately adjacent to the at least one directional button absent any intervening button.

6. The apparatus of claim 1 wherein the left and right mouse buttons are positioned on opposite regions of the electronic device.

7. An apparatus, comprising:
a hand-held electronic device having a small form factor;
a keyboard for the electronic device;
at least one directional button included with the keyboard; and
left and right mouse buttons located on opposing end regions of the keyboard, the left and right mouse buttons being located in a manner to allow the left and right mouse buttons to each be actuated by a finger from a different hand of a user.

8. The apparatus of claim 7 wherein the left and right mouse buttons are located, respectively, at a left region and at a right region of the keyboard.

9. The apparatus of claim 9, further comprising a mouse device on the keyboard.

10. The apparatus of claim 9 wherein the mouse device comprises a touchpad located adjacent to the right mouse button.

11. A system, comprising:
a hand-held portable electronic device having a small form factor;
a mouse assembly located on the portable electronic device, the mouse assembly including a plurality of directional buttons that are positioned in close proximity to a mouse button and that surround the mouse on at least three sides; and
left and right mouse click buttons.

12. The system of claim 11 wherein the plurality of directional buttons that surround the mouse button are positioned in a manner that actuation of the mouse button or any of the directional buttons may be performed with a same single fingertip.

13. The system of claim 11, further comprising a keyboard located on the portable electronic device, the mouse assembly being positioned adjacent to either a right region or a left region of the keyboard.

14. The system of claim 11 wherein actuation of the directional buttons results in a panned navigation, with an on-screen cursor corresponding to the mouse button generally stationary.

15. The system of claim 11, further comprising a plurality of buttons, including a tab key and an enter key, that are located off-keyboard on the portable electronic device.

16. The system of claim 11, further comprising:
a keyboard located on the portable electronic device; and
a plurality of hot keys included as part of the keyboard and that are associated with a corresponding plurality of applications, wherein actuation of any one of the hot keys accelerates activation of its corresponding application without having to perform on-screen navigation for that application.

17. The system of claim 11 wherein the mouse button is self-centering.

18. A hand-held electronic apparatus having a small form factor, the apparatus comprising:
a housing;
a keyboard located on the housing;
a mouse assembly integrated with the housing, the mouse assembly including a mouse button and a plurality of directional buttons that at least partially surround the mouse button, the directional buttons being arranged in close proximity to the mouse button, absent an intervening button between any of the directional buttons and the mouse button, to permit a same single fingertip to actuate the mouse button or one of the directional buttons; and
a plurality of other buttons located on the housing and off the keyboard, including user-programmable buttons and off-keyboard tab and enter keys, these off-keyboard keys being located at a rear side of the housing; and
left and right mouse buttons positioned on the housing.

19. The apparatus of claim 18 wherein the left and right mouse buttons are collectively located adjacent to the plurality of directional buttons.

20. The apparatus of claim 18 wherein the left and right mouse buttons are located on opposing regions of the keyboard.

21. A system, comprising:
a hand-held portable computer having a small form factor;
a mouse assembly located on the portable computer, the mouse assembly including a plurality of directional buttons that are positioned adjacent to a mouse button; and
a keyboard located on the portable computer, the mouse assembly being positioned at either a right region or a left region of the keyboard; and
left and right mouse buttons.

22. The system of claim 21 wherein the left and right mouse buttons are collectively located adjacent to the plurality of directional buttons.

23. The system of claim 21 wherein the left and right mouse buttons are located on opposing regions of the keyboard in a manner to allow the left and right mouse buttons to each be actuated by a finger from a different hand of a user.

24. A hand-held electronic apparatus having a small form factor, the apparatus comprising:
a mouse assembly including a mouse button and a plurality of directional buttons that at least partially surround the mouse button, the directional buttons being arranged immediately adjacent to the mouse button to permit a same single fingertip to actuate the mouse button or one of the directional buttons; and
a movable selection element having a speed and direction that can be controlled based on a degree of fingertip pressure applied to either the mouse button or to any one of the directional buttons; and
left and right mouse buttons.

25. The apparatus of claim 24 wherein increased fingertip pressure can cause a corresponding increase in movement speed of the selection element.

26. The apparatus of claim 24, further comprising a display screen, wherein the selection element includes a cursor that can be presented on the display screen.

27. The apparatus of claim 24 wherein each of the directional buttons are spaced apart from the mouse button.

28. The system of claim 24 wherein the left and right mouse buttons are located on opposite keyboard regions.

29. The system of claim 24 wherein the left and right mouse buttons are located adjacent to the plurality of directional buttons.

30. A hand-held electronic apparatus having a small form factor, the apparatus comprising:
a mouse assembly including a mouse device and a plurality of directional buttons that at least partially surround the mouse device, the directional buttons being arranged in close proximity to the mouse button to permit a same single fingertip to actuate the mouse device or one of the directional buttons, the mouse device usable for selection and for both vertical and horizontal navigation; and
left and right mouse buttons.

31. The apparatus of claim 30 wherein the mouse device comprises a touchpad.

32. The apparatus of claim 30 wherein the mouse device comprises a movable element.

33. The apparatus of claim 30 wherein the left and right mouse buttons are located on opposite keyboard regions.

34. The apparatus of claim 30 wherein the left and right mouse buttons are located adjacent to the plurality of directional buttons.
